(19) United States
(12) Patent Application Publication
(10) Pub. No.: US 2016/0228886 A1
(43) Pub. Date: Aug. 11, 2016

(54) Water Outlet Structure for Generating Cone Shaped Water and A Shower Head Mounting the Same

(71) Applicant: KYLIN Sanitary Technology (Xiamen) Co., Ltd., XIAMEN (CN)

(72) Inventors: Wenjuan Lin, XIAMEN (CN); Qingshuang Li, XIAMEN (CN); Xijie Deng, XIAMEN (CN); Hui Huang, XIAMEN (CN); Fuhui Zhong, XIAMEN (CN)

(73) Assignee: KYLIN Sanitary Technology (Xiamen) Co., Ltd., XIAMEN (CN)

(21) Appl. No.: 14/989,797

(22) Filed: Jan. 7, 2016

(30) Foreign Application Priority Data
Feb. 7, 2015 (CN) 201520091431.3

(51) Int. Cl. B05B 1/18; B05B 1/06

(52) U.S. Cl. CPC B05B 1/185; B05B 1/06

(57) ABSTRACT

A water outlet structure for generating cone shaped water comprises a water inlet, a trumpet shaped water outlet formed at the bottom of the water inlet, a water diversion hub located inside an inner chamber of the trumpet shaped water outlet to divide the inner chamber into at least two water outlet chambers, a mushroom shaped lug boss formed at the bottom of the water diversion hub and an annular water outlet sink formed between an outer edge of the mushroom shaped lug boss and the trumpet shaped water outlet. The present invention can satisfy a favorable showing experience, the same effect is achieved by using much less water with above structure, which saves much water to some extent.

### FIELD OF THE INVENTION

The present invention relates to a water outlet structure and a shower head mounting the same, and more specifically relates to a water outlet structure for generating cone shaped water and a shower head mounting the same.

### BACKGROUND OF THE INVENTION

The existing shower device has a demanding need for the shape of the generated water, not only in the water-saving part, but also the higher requirement for the different feelings when the spray contacts with human body. The existing water outlet structure and the shower head mounting the above structure have the following disadvantages: the shape of the generated water is usually columnar or line shaped; the spraying is inhomogeneous and the pressure is not high enough, a favourable impact force and particle feeling cannot generated with the existing device.

### SUMMARY OF THE INVENTION

In order to overcome the drawbacks of the existing shower device, the present invention provides a water outlet structure for generating cone shaped water and a shower head mounting the same. With this special structure, a water flow concentration is generated, a favourable strong impact force and particle feeling can be generated due to a higher water pressure of this structure. At the same time, the present structure is water-saving.

In order to achieve the above goals, the technical solution is as follow:

A water outlet structure for generating cone shaped water comprises a water inlet, a trumpet shaped water outlet formed at the bottom of the water inlet, a water diversion hub located inside an inner chamber of the trumpet shaped water outlet to divide the inner chamber into at least two water outlet chambers, a mushroom shaped lug boss formed at the bottom of the water diversion hub and an annular water outlet sink formed between an outer edge of the mushroom shaped lug boss and the trumpet shaped water outlet.

Furthermore, an angle of a mouth of the trumpet shaped water outlet ranges from 5 to 15 degrees.

Furthermore, a water inlet passage is formed on the top of the water inlet for collecting water and a diameter of the water inlet passage is larger than or equals to a maximal external diameter of the mushroom shaped lug boss.

Furthermore, two rib plates are located on the water diversion hub to divide the inner chamber of the trumpet shaped water outlet into at least two water outlet chambers.

Furthermore, the outer edge of the mushroom shaped lug boss comprises an arc surface.

A shower head for generating cone shaped water, wherein a surface cover of a shower head arranges above water outlet structure for generating cone shaped water thereon.

The shower head for generating cone shaped water further comprises a head body and a surface cover cooperated with the head body. The water outlet structure and the surface cover form an integrated structure.

The central of the surface cover is set with a relative large water outlet structure. The relative large water outlet structure is surrounded by a group of small water outlet structures. A group of general water owlet nozzles are arranged on an outer peripheral of the surface cover in an array-management.

Adopting the above technical solution, the present invention speeds the water flows through the inlet passage having the water collecting function. The water flows are concentrated and the water pressure is increased due to a mutation when the water flows through the intersection area between the trumpet shaped water outlet and the water diversion hub, a much more intense collision effect is generated inside the channel. After the collision, the water spray onto the users' body, a larger area showering and more intense impact force and particle feeling are achieved. At the same time, the same effect is achieved by using much less water with above structure, which saves much water to some extent.

### BRIEF DESCRIPTION OF THE DRAWINGS

FIG. 1 is a schematic view of a water outlet structure of the present invention.

FIG. 2 is an exploded view of a shower head mounting the water outlet structure of the present invention.

FIG. 3 is a schematic view of the assembly of the shower head mounting the water outlet structure of the present invention.

FIG. 4 is a diagrammatic cross-section view of the shower head mounting the water outlet structure of the present invention.

FIG. 5 is a partial enlarged view of the present invention.

### DETAILED DESCRIPTION OF THE INVENTION

A detailed description of the present invention is presented with the accompanying drawings and the specific embodiment.

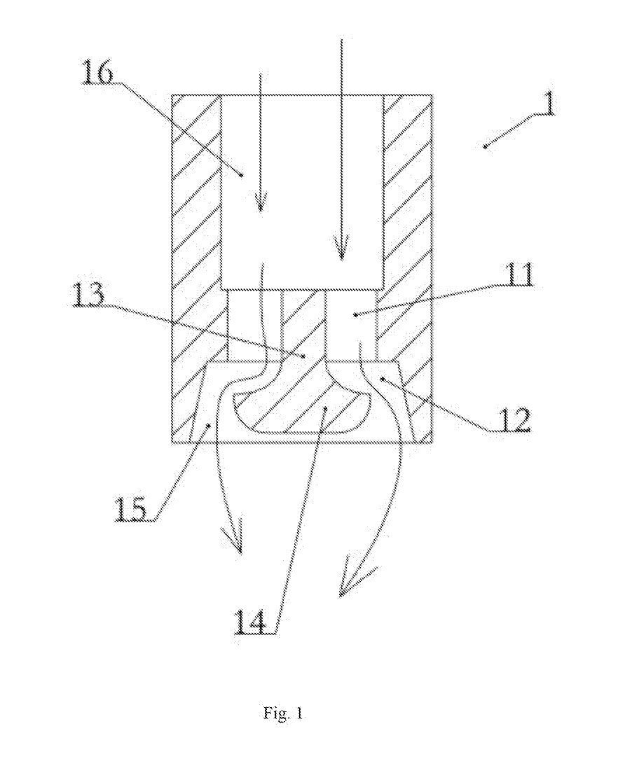

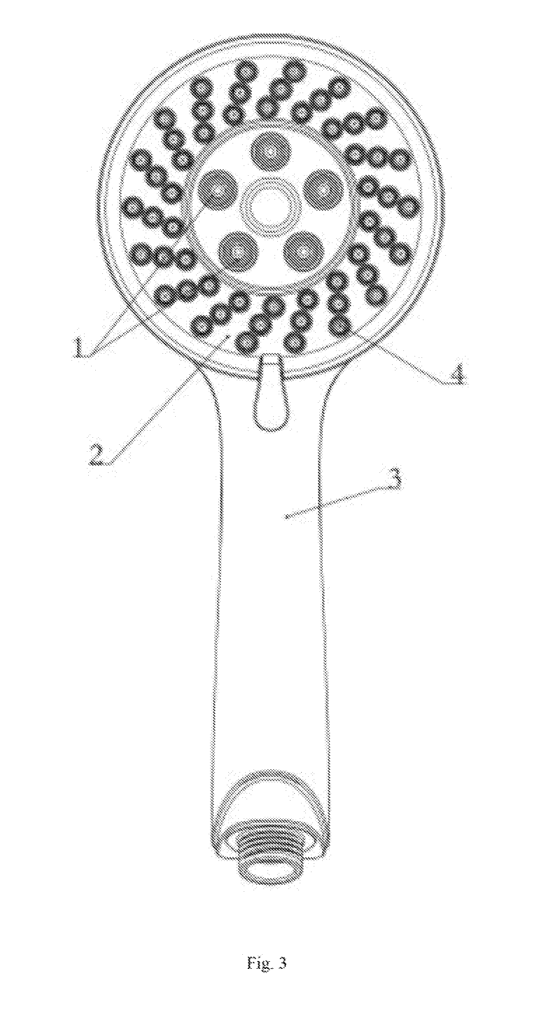

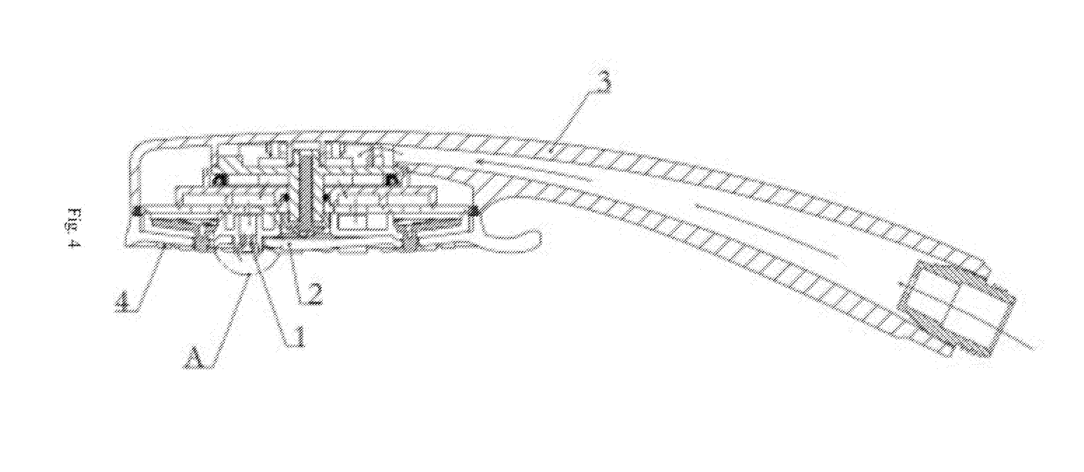

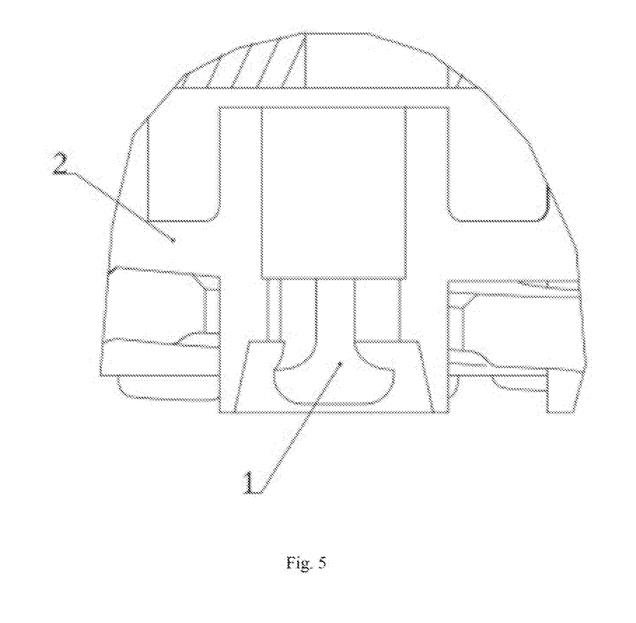

Referring to FIGS. 1-5, a water outlet structure 1 for generating cone shaped water comprises a water inlet 11, a trumpet shaped water outlet 12 formed at the bottom of water inlet 11, as water diversion hub 13 located inside an inner chamber of the trumpet shaped water outlet to divide the inner chamber into at least two water outlet chambers, a mushroom shaped lug boss 14 formed at the bottom of water diversion hub 13 and an annular water outlet sink 15 formed between an outer edge of the mushroom shaped lug boss and trumpet shaped water outlet. The outer edge of the mushroom shaped lug boss is an arc surface.

In practical use, an angle of a mouth of trumpet shaped water outlet 12 ranges from 5 to 15 degrees. A water inlet passage 16 is formed on the top of water inlet 11 for collecting water; and wherein a diameter of water inlet passage 16 is larger than a maximal of an external diameter of the mushroom shaped lug boss.

Two rib plates are located on water diversion hub 13 to divide the inner chamber of the trumpet shaped water outlet into at least two water outlet chambers.

The water outlet structure of the present invention can be mounted onto various water outlet products like sprinkler, over-head shower or the like. Taking the shower head which mounts the water outlet structure for an example, a shower head for generating cane shaped water, wherein a surface cover 2 of the shower head is set with water outlet structure 1 for generating cane flame shaped water thereon.

Preferably, the shower head further comprises a head body, a surface cover cooperated with the head body. The water outlet structure and the surface cover form an integrated structure.

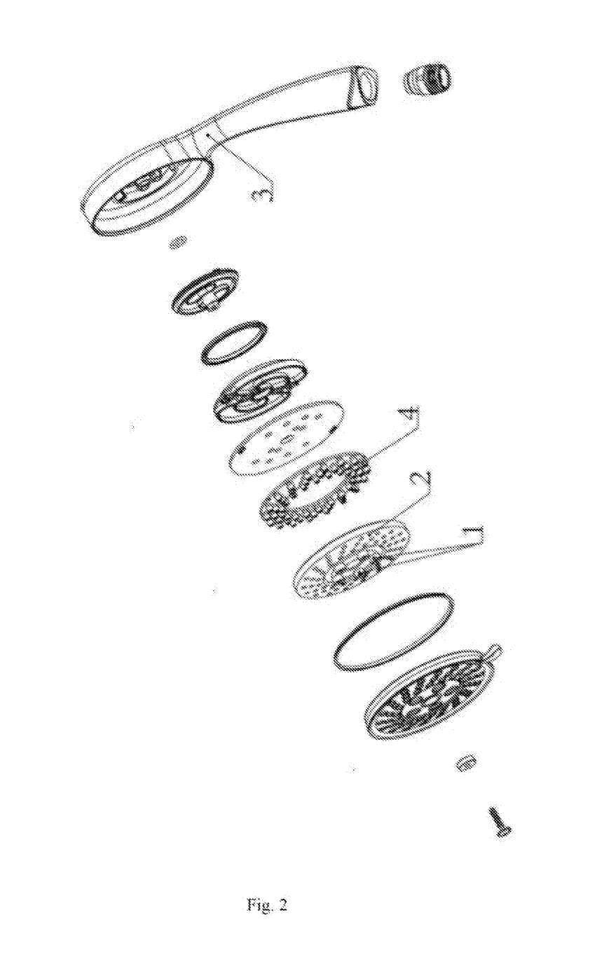

Referring to the shower head of FIG. 2, the central of the surface cover 2 is set with a relative large water outlet structure 1. Relative large water outlet structure 1 is surrounded by a group of small water outlet structures 1. A group of general water outlet nozzles 4 are arranged on the outer peripheral of the surface cover in an array-arrangement.

When the shower head works in a normal condition, the water flows speed up the water inlet passage having a water collecting function. The water flows are concentrated and the water pressure is increased due to a mutation when the water flows through the intersection area between the trumpet shaped water outlet and the water diversion hub, a much more intense collision effect is generated inside the channel. After the collision, the water spray onto the users' body, a larger area showering and more intense impact force and particle feeling are achieved. At the same time, the same effect is achieved by using much less water with above structure, which saves much water to some extent.

The above description merely describes the preferred embodiment of the present invention, and does not intend to limit the scope of the present invention. Those skilled in the art should understand that equivalent replacement or modifications can be made based on the principles of the present invention. However, all such modifications and replacement without departing from the principle shall fall within the scope of the present invention.

1. A water outlet structure for generating cone shaped water, comprising:
a water inlet;
a trumpet shaped water outlet formed at the bottom of the water inlet;
a water diversion hub located inside an inner chamber of the trumpet shaped water outlet to divide the inner chamber into at least two water outlet chambers;
a mushroom shaped lug boss formed at the bottom of the water diversion hub;
an annular water outlet sink formed between an outer edge of the mushroom shaped lug boss and the trumpet shaped water outlet.

2. The water outlet structure for generating cone shaped water of claim 1, wherein an angle of a mouth of the trumpet shaped water outlet ranges from 5 to 15 degrees.

3. The water outlet structure for generating cone shaped water of claim 1, wherein a water inlet passage is formed on top of the water inlet for collecting water; and
wherein a diameter of the water inlet passage is larger than or equal to a maximal external diameter of the mushroom shaped lug boss.

4. The water outlet structure for generating cone shaped water of claim 1, wherein two rib plates are located on the water diversion hub to divide the inner chamber of the trumpet shaped water outlet into at least two water outlet chambers.

5. The water outlet structure for generating cone shaped water of claim 3, wherein the outer edge of the mushroom shaped lug boss forms an arc surface.

6. A shower head for generating cone shaped water, wherein a surface cover of the shower head is set with the water outlet structure for generating a cone shaped water of claim 1 thereon.

7. The shower head for generating cone shaped water of claim 6, further comprising:
a head body;
the surface cover cooperated with the head body;
wherein the water outlet structure and the surface cover are an integrated structure.

8. The shower head for generating cone shaped water of claim 7, wherein the central of the surface cover is set with a relative large water outlet structure; the relative large water outlet structure is surrounded by a group of small water outlet structures; a group of general water outlet nozzles are arranged on an outer peripheral of the surface cover in an array-arrangement.
